(19) United States
(12) Patent Application Publication
(10) Pub. No.: US 2026/0310274 A1
(43) Pub. Date: Oct. 8, 2026

(54) VEHICLE DIAGNOSTIC TOOL WITH AUTONOMOUS POWER ON FUNCTIONALITY

(71) Applicant: Innova Electronics Corporation, Irvine, CA (US)

(72) Inventors: Phuong PHAM, Fountain Valley, CA (US); Son LE, Garden Grove, CA (US); Nguyen Tran DINH, Ho Chi Minh City (VN); Hung PHAN, Anaheim, CA (US); Ly BACH, Ho Chi Minh City (VN); Le Huu THAI, Ho Chi Minh City (VN); Vo Thi Hong NHI, Ho Chi Minh City (VN); Khanh LE, Ho Chi Minh City (VN); Suong NGUYEN, Dak Lak (VN); Benjamin PHAM, Fountain Valley, CA (US)

(21) Appl. No.: 19/170,249

(22) Filed: Apr. 4, 2025

(51) Int. Cl. G06F 1/28; G07C 5/00; G07C 5/08

(52) U.S. Cl. CPC G06F 1/28; G07C 5/008; G07C 5/0825; G07C 2205/02

(57) ABSTRACT

A method of facilitating autonomous power source determination and powering-on of an automotive diagnostic tool adapted to retrieve vehicle data from a vehicle. The method includes receiving a signal from a vehicle via a data link connector on the tool upon connection of the data link connector to a diagnostic port on the vehicle. The method further includes determining a power supply status for a chip set on the tool as being either a POWERED status, wherein the chip set is powered by a local battery on the tool, or an OFF status, wherein the chip set is not receiving power from the local battery on the tool. When the power supply status is the OFF status, the method includes using the vehicle signal to facilitate transition the power supply status of the chip set from the OFF status to the POWERED status.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Technical Field

The present disclosure relates generally to an automotive diagnostic tool, and more specifically to an automotive diagnostic tool having autonomous monitoring and directing of power from one or more power sources to a chip set on the tool.

### Description of the Related Art

The incorporation of computers and other electrical components (e.g., electrical sensors) into vehicles has resulted in a significant amount of vehicle data being available for purposes of vehicle diagnostics. As such, modern vehicle diagnostic equipment, such as code readers, scan tools, and the like, are configured to access the available vehicle data and analyze the data to arrive at a diagnostic conclusion. Most diagnostic equipment is configured to access the vehicle data by being plugged into an on-board diagnostic-II (OBD-II) port on a vehicle. Once plugged into the OBD-II port, the tool may communicate with one or more computers, sensors or data sources to retrieve the data from the vehicle.

In order for conventional diagnostic tools to function, the tools must be powered on, and thus, conventional diagnostic tools may include an onboard battery to supply power during use. However, conventional diagnostic tools are not configured to power on in response to being plugged into the OBD-II port. As such, a level of familiarity or understanding in how to operate the tool may be a barrier for those that have not used automotive diagnostic tools before. For instance, a power button may need to be actuated to turn the tool on. If a user is not familiar with the location of the power button, or that actuating the power button is a requirement for operation of the tool, the user may not be able to properly operate the tool. Furthermore, in many cases, particularly for novice users, after purchasing a tool, the tool may sit on a shelf before use and the battery may slowly drain. When the tool is finally used, the tool may not power on due to the drain on the battery. In such instances, the user may return the tool based on the mistaken belief that the tool is broken.

Furthermore, it is understood that many vehicle diagnostic tools may remain plugged into the OBD-II port for several operational cycles. For instance, a diagnostic dongle is a well-known diagnostic device that is small in size, and can remain connected to the OBD-II port for an extended period of time. However, when the diagnostic tools remain connected and on, the tools may draw a considerable amount of power from their power source. As such, the power source may become depleted sooner than is desired.

Accordingly, there is a need in the art for an automotive diagnostic tool capable of monitoring power consumption of the tool and autonomously optimizing power consumption on the tool. In one respect, there is a need to autonomously monitor power supply from several power sources and facilitate the supply of power to a chip set on the tool in response to the tool being plugged into the diagnostic port on the vehicle. In another respect, there is a need to monitor the operational status of the vehicle and transition the tool into a sleep mode when the vehicle is off. Various aspects of the present disclosure address these particular needs, as will be discussed in more detail below.

### BRIEF SUMMARY

In accordance with one embodiment of the present disclosure, there is provided a method of facilitating autonomous power source determination and powering-on of an automotive diagnostic tool adapted to retrieve vehicle data from a vehicle. The method includes receiving a power signal from a vehicle via a data link connector on the automotive diagnostic tool upon connection of the data link connector to a diagnostic port on the vehicle.

The method further includes determining, by a processor on the tool, a power supply status for a chip set on the tool as being either a POWERED status, wherein the chip set is powered by a local battery on the tool, or an OFF status, wherein the chip set is not receiving power from the local battery on the tool. When the power supply status is the OFF status, the method includes using the vehicle power signal to facilitate transition the power supply status of the chip set from the OFF status to the POWERED status.

The step of using the vehicle power signal to transition the power supply status of the chip set from the OFF status to the POWERED status may include actuating a POWER BUTTON using the vehicle power signal to supply power from a local battery. The method may also include the step of determining whether the power supply status transitioned from the OFF status to the POWERED status after actuating the POWER BUTTON, and when the power status remains in the OFF status, using the vehicle power signal to directly provide power to the chip set to transition the power supply status to the POWERED status.

The method may also include the step of illuminating a display screen in response to the chip set being transitioned from the OFF status to the POWERED status. The step of illuminating the display screen may occur independent of any user input being made to the tool.

The receiving step, the determining step, and the using step may all proceed independent of a user pressing a POWER button.

The chip set may be an android chip set.

According to another aspect of the present disclosure, there is provided an automotive diagnostic tool adapted to retrieve vehicle data from a vehicle and facilitate powering-on of the tool. The automotive diagnostic tool includes a hand-holdable housing and a data link connector coupled to the housing and configured to be plug-connectable with a diagnostic port on the vehicle. The tool additionally includes a chip set within the housing and configured to implement a diagnostic functionality of the automotive diagnostic tool. The tool further includes a battery configured to supply power to the chip set in response to actuation of a POWER BUTTON coupled to the housing. The tool also includes a power control circuit configured to receive a power signal from the vehicle via the data link connector upon connection of the data link connector to a diagnostic port on the vehicle, determine a power supply status for a chip set on the tool as being either a POWERED status, wherein the chip set is powered by the battery on the tool, or an OFF status, wherein the chip set is not receiving power from the battery on the tool, and when the power supply status is the OFF status, using the vehicle power signal to facilitate transition the power supply status of the chip set from the OFF status to the POWERED status.

The power control circuit is configured to actuate a POWER BUTTON in operative communication with the battery to supply power from the battery to facilitate transition of the power supply status of the chip set from the OFF status to the POWERED status.

The power control circuit may be further configured to determine whether the power supply status transitioned from the OFF status to the POWERED status after actuating the POWER BUTTON, and when the power status remains in the OFF status, using the vehicle power signal to directly provide power to the chip set to transition the power supply status to the POWERED status.

The automotive diagnostic tool may additionally include a display screen, and the power control circuit may be further configured to illuminate the display screen in response to the chip set being transitioned from the OFF status to the POWERED status. The illumination of the display screen occurs independent of any user input being made to the tool.

The functionalities of the power control circuit may all proceed independent of a user pressing a POWER button.

The power control circuit may be configured to generate a wake-up command signal to the chip set. The power control circuit may also be configured to detect an engine of the vehicle being turned on, and generate the wake-up command signal autonomously in response to the detection of the engine being turned on.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic view of an automotive diagnostic tool having autonomous power monitoring and supply;

FIG. 2 is a flow chart associated with autonomous power supply identification and selection;

FIG. 3 is a flow chart associated with transitioning a chip set from a SLEEP status to a POWERED status;

FIG. 4 is a schematic circuit diagram of a circuit configured to detect voltage oscillations on a vehicle data bus for purposes of detecting engine operation;

FIG. 5 is a schematic circuit diagram of a circuit configured to detect a changes in vehicle voltage for purposes of detecting engine operation;

FIG. 6 is a chart depicting a change in vehicle voltage associated with starting an engine; and

FIG. 7 is a schematic circuit diagram of a circuit configured to detect a change in vehicle voltage associated with starting an engine.

Common reference numerals are used throughout the drawings and the detailed description to indicate the same elements.

### DETAILED DESCRIPTION

The detailed description set forth below in connection with the appended drawings is intended as a description of certain embodiments of an automotive diagnostic tool with autonomous power supply functionality and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating preferred embodiments of the present disclosure, and are not for purposes of limiting the same, there is provided an automotive diagnostic tool 10 adapted to retrieve vehicle data from a vehicle 12 and facilitate automatic powering-on of the tool 10. It is contemplated that the tool 10 may be powered by multiple power sources, including a local battery 14 or a power signal supplied by the vehicle 12 when the tool 10 is connected to the vehicle 12. In response to the tool 10 being connected to the vehicle 12, a power control circuit 16 on the tool 10 may monitor supply of power to a chip set 18 on the tool 10 and may facilitate power supply from an alternative source when a primary source of power is found to be insufficient. Thus, if the local battery 14 is dead, or if a user may not be familiar with activating the local battery 14, the tool 10 may be configured to autonomously facilitate supply of power from an available power source in response to the tool 10 being connected to the vehicle 12.

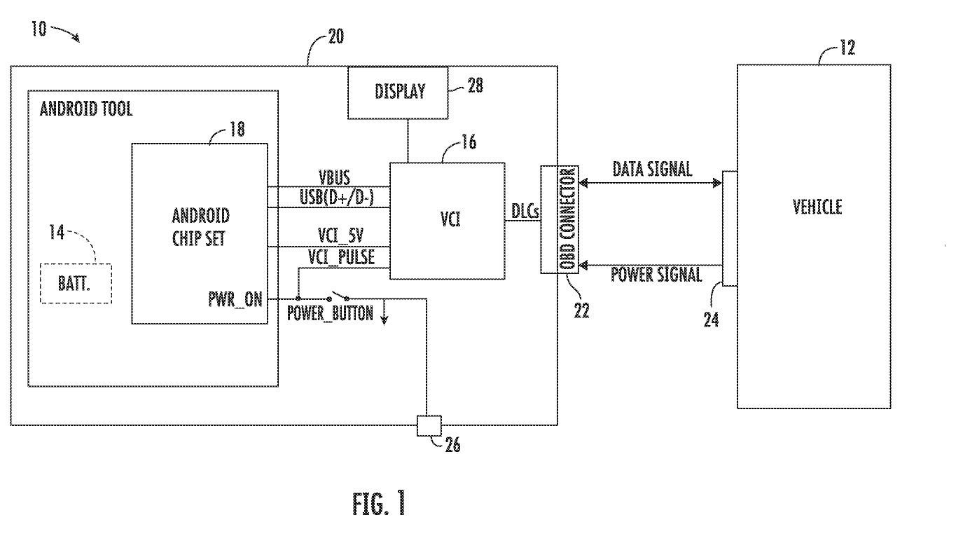

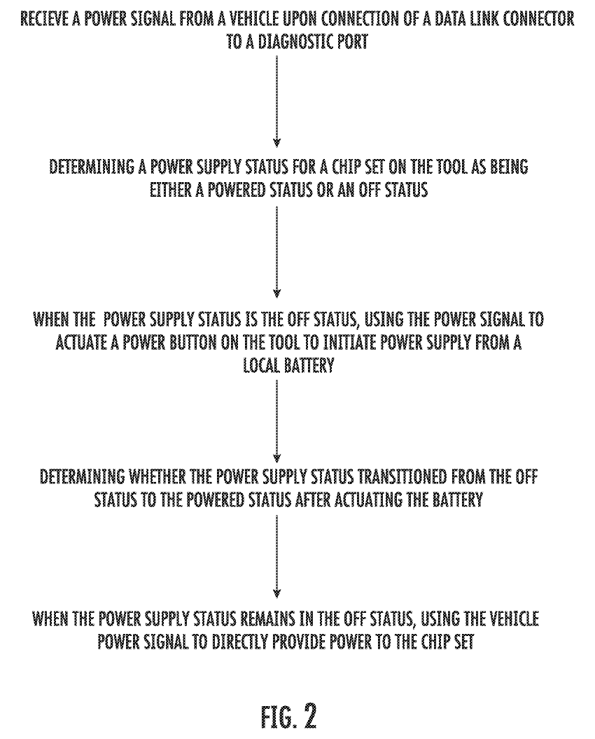

FIG. 1 is a schematic depicting an automotive diagnostic tool 10 includes a hand-holdable housing 20 and a data link connector 22 coupled to the housing 20 and configured to be plug-connectable with a diagnostic port 24 on the vehicle 12. The automotive diagnostic tool 10 may include a dongle, code reader, scan tool, tablet, data logger, telematics tool, or any other automotive diagnostic tool known by those skilled in the art. The housing 20 may be sized to be hand-holdable by a user. Furthermore, some implementations of the tool 10 (e.g., a dongle) may be configured to remain connected to the diagnostic port 24 on the vehicle 12 for an extended period of time (e.g., for weeks, months, etc.), and thus, the tool 10 may be small enough to not interfere with the user’s operation of the vehicle 12.

Given the wide-ranging scope of the automotive diagnostic tool 10, various aspects of the present disclosure may be configured to enable power management in response to connecting the tool to the diagnostic port 24. In this respect, it is contemplated that certain embodiments of the automotive diagnostic tool 10 may be used when not connected to the diagnostic port 24, such as to access related vehicle content (e.g., vehicle-specific service bulletins, accessing online diagnostic content, etc.), in which case the automotive diagnostic tool 10 may be powered by a local battery. However, in response to connection of the tool 10 to the diagnostic port 24, the power management resources on the tool 10 may autonomously evaluate the available power signal from the vehicle 12 and transition the tool 10 to use the vehicle’s power signal to power and/or charge the tool 10. Upon disconnection of the tool 10 from the diagnostic port 24, the tool 10 may be configured to autonomously transition from the vehicle’s power signal to the local battery on the tool 10. The transition from one power source to another power source may be implemented without disrupting any current operation or function being performed on the tool 10 at the time of the transition. It is also contemplated that the automotive diagnostic tool 10 may include hardware designed to remain connected to the diagnostic port 24 during repeated operation of the vehicle 12, such as a diagnostic dongle. As such, the power management resources on the tool 10 may be configured to autonomously transition between a sleep mode (e.g., a power saving mode), and an awake mode based on the operational status of the vehicle. In both the sleep mode and the awake mode, the power management resources may evaluate available power sources, either from the vehicle or the tool, and make a decision as to the most optimal source of power. The transition between the sleep mode and the awake mode may be via a detected signal on the vehicle bus, engine crank, or engine on signal.

The diagnostic port 24 may be an on-board diagnostics II (OBD-II) port that is in operative communication with one or more communication buses on the vehicle 12. Vehicle identification information, vehicle data (e.g., operational data, diagnostic data, sensor data, etc.) may be accessible via the diagnostic port on the vehicle 12. The tool 10 may also be able to communicate with one or more electronic control units (ECUs), sensors, systems computers, etc., that may reside on the vehicle 12 through the diagnostic port 24. The diagnostic port 24 may also be in communication with the vehicle’s battery such that a vehicle power signal may be supplied to the tool 10 via the diagnostic port 24 when the tool 10 is connected to the diagnostic port 24. The configuration of the data link connector 22 may be complementary to that of the diagnostic port 24 to facilitate plug connection therebetween.

The tool 10 additionally includes a chip set 18 within the housing 20 and configured to implement a diagnostic functionality of the automotive diagnostic tool 10. In this regard, the chip set 18 may include one or more processors, circuits, or other hardware necessary to implement the intended functionalities of the tool 10. The chip set 18 may include a memory circuit (e.g., random-access memory, flash memory, etc.) having pre-programmed instructions stored thereon and which are capable of being implemented by a processor during operation of the tool 10 to facilitate the functionalities described herein. The memory circuit may also have the capability of storing data and information that may be retrieved from the vehicle 12. The memory circuit may include Randon Access Memory (RAM), read-only memory (ROM), flash memory, or other memory resources known by those skilled in the art. It is contemplated that the tool 10 may also be capable of uploading any data and information retrieved from the vehicle 12 to a remote resource, such as a remote database or nearby device (e.g., smartphone). The remote database or device may be configured to analyze the data to derive a most likely solution. For more information regarding analysis of diagnostic data, please refer to the following U.S patents and published patent applications, owned by Innova Electronic Corporation, which is also the owner of the present disclosure: U.S. Patent No. 6,807,469, entitled AUTO DIAGNOSTIC METHOD AND DEVICE, U.S. Patent No. 6,925,368, entitled AUTO DIAGNOSTIC METHOD AND DEVICE, U.S. Patent No. 7,620,484, entitled AUTOMOTIVE MOBILE DIAGNOSTICS, U.S. Patent No. 8,019,503, entitled AUTOMOTIVE DIAGNOSTIC AND REMEDIAL PROCESS, U.S. Patent No. 8,370,018, entitled AUTOMOTIVE DIAGNOSTIC PROCESS, U.S. Patent No. 8,909,416, entitled HANDHELD SCAN TOOL WITH FIED SOLUTION CAPABILITY, U.S. Patent No. 9,026,400, entitled DIAGNOSTIC PROCESS FOR HOME ELECTRONIC DEVICES, U.S. Patent No. 9,177,428, entitled PREDICTIVE DIAGNOSTIC METHOD, U.S. Patent No. 9,646,432, entitled HAND HELD DATA RETRIEVAL DEVICE WITH FIXED SOLUTION CAPABILITY, U.S. Patent No. 10,643,403, entitled PREDICTIVE DIAGNOSTIC METHOD AND SYSTEM, U.S. Patent Application Pub. No. 2013/0297143, entitled METHOD OF PROCESSING VEHICLE DIAGNOSTIC DATA, U.S. Patent Application Pub. No. 2019/0304208, entitled SYSTEM AND METHOD FOR PROACTIVE VEHICLE DIAGNOSIS AND OPERATIONAL ALERT, U.S. Patent Application Pub. No. 2019/0304213, entitled SYSTEM AND METHOD FOR PROACTIVE VEHICLE DIAGNOSIS AND OPERATIONAL ALERT, U.S. Patent Application Serial No. 18/328,289 entitled SYSTEM AND METHOD FOR GUIDED VEHICLE DIAGNOSTICS, and U.S. Patent Application Serial No. 18/328,451 entitled VEHICLE DIAGNOSTICS WITH INTELLIGENT COMMUNICATION INTERFACE, the entire contents of each of which is expressly incorporated herein by reference. The chip set 18 may be configured to operate in any number of operating systems, including, but not limited to ANDROID, IOS, or other operating systems known in the art.

The tool 10 further includes a battery 14 configured to supply power to the chip set 18. The battery 14 may be rechargeable or replaceable. The tool 10 may also include a power button 26 coupled to the housing 20 and located on the housing 20 so as to be manually actuatable by a user. In this regard, the power button 26 may be depressed, slid, or otherwise actuated by the user as an indication by the user to supply power from the battery 14 to the chip set 18. The power button 26 may have an ON position or mode, as well as an OFF position or mode, which allows the user to selectively turn the tool 10 on or off.

The tool 10 also includes a power control circuit 16 within the housing 20 and configured to monitor and control the supply of power to the chip set 18 from available power sources, such as the battery 14 and the vehicle 12. In this regard, the power control circuit 16 may be configured to receive a power signal from the vehicle 12 via the data link connector upon connection of the data link connector 22 to a diagnostic port 24 on the vehicle 12. Before using the power from the vehicle 12 to power the chip set 18, the power control circuit 16 may determine whether the chip set 18 is already being powered by the battery 14. The power control circuit 16 may detect the power status via the USB communication path in FIG. 1. In this regard, the power control circuit 16 may determine a power supply status for a chip set 18 on the tool 10 as being one of a POWERED status, with the chip set 18 is powered by the battery 14 on the tool 10, or an OFF status, with the chip set 18 not receiving power from the battery 14 on the tool 10. When the power supply status is the OFF status, the power control circuit 16 may use the vehicle power signal to facilitate transition the power supply status of the chip set 18 from the OFF status to the POWERED status.

In one implementation, the power control circuit 16 is configured to utilize the vehicle power signal to actuate the power button 26, which has the same effect as manually actuating the power button. Once the power button 26 is actuated by the power control circuit 16, the power is supplied to the chip set 18 from the battery 14, resulting in the power supply status of the chip set 18 transitioning from the OFF status to the POWERED status.

The power control circuit 16 may be further configured to determine whether the power supply status transitioned from the OFF status to the POWERED status after actuating the power button. When the power status remains in the OFF status, the power control circuit 16 may use the vehicle power signal to directly provide power to the chip set 18 to transition the power supply status to the POWERED status.

In this respect, the power control circuit 16 may treat the battery 14 as a primary power supply and initially check to see whether the chip set 18 is being supplied power from the battery 14 before taking any action. If the power control circuit 16 detects no power being supplied to the battery 14, the power control circuit 16 will initially try and actuate the power button 26 to direct power from the battery 14 to the chip set 18. The actuation of the power button 26 may be facilitated through an electronic pulse (e.g., VCI _Pulse) to the power button 26. If the chip set 18 remains without power after actuating the power button 26, the power control circuit 16 will then use power from the vehicle 12 (e.g., the vehicle power signal) to provide power to the chip set 18.

The power control circuit 16 may include one or more processors or other hardware needed to implement the functionalities described herein.

The automotive diagnostic tool 10 may additionally include a display screen 28, and the power control circuit 16 may be further configured to illuminate the display screen 28 in response to the chip set 18 being transitioned from the OFF status to the POWERED status. The illumination of the display screen 28 may occur independent of any user input being made to the tool 10. Furthermore, the functionalities of the power control circuit 16 may all proceed independent of a user pressing the power button 26.

Therefore, the tool 10 may be configured to ensure powering of the tool 10 automatically, without user input, in response to the tool 10 being connected to the diagnostic port 24 of the vehicle 12. If the tool 10 is already receiving power from the battery 14 prior to the connection, the power supply from the battery 14 may continue. However, if power is not being supplied by the battery, the power signal from the vehicle 12 may be used to actuate the battery 14 via actuation of the power button 26. If the battery 14 is dead, then the power supply from the vehicle 12 may be used to power the tool 10. In addition, the power control circuit 16 may also be configured to not only utilize the vehicle power as the power supply to the chip set 18, but the vehicle power may also be used to recharge the battery 14. Thus, even for inexperienced users, all that may be required to power on the tool 10 is to connect the tool the diagnostic port 24 of the vehicle 12.

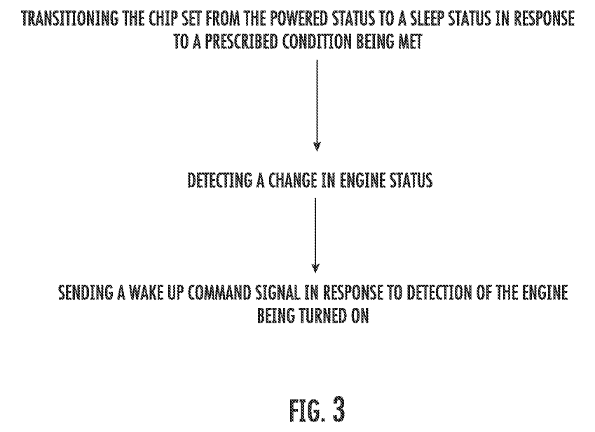

While the foregoing discusses providing power to the chip set 18 on the tool 10, the following discussion, as well as FIGS. 3-7, relates to controlling the power supply to optimize power consumption. It is contemplated that certain diagnostic tools, such as diagnostic dongles, may remain connected to the diagnostic port for an extended period of time, even during periods when the vehicle 12 is off and the user is not conducting diagnostic testing. As such, during such periods of inactivity, it may be desirable to transition the tool 10 into a SLEEP status to reduce the power consumption. However, when the vehicle 12 is turned back on, it may be desirable to wake-up the tool 10 and transition the tool 10 from the SLEEP status to a POWERED/AWAKE status. To that end, one embodiment of the power control circuit 16 is configured to generate a wake-up command signal to the chip set 18. The wake-up command may be triggered by one or more conditions detected by the power control circuit 16.

The transition of the tool 10 from the POWERED status to the SLEEP status may occur in response to a number of preprogrammed conditions, such that when the condition(s) is met, the power control circuit 16 may generate a command to facilitate transition from the POWERED status to the SLEEP status. One condition may include the tool 10 being in the POWERED status for a predetermined period of time, as may be detected by the power control circuit 16. For instance, if the tool 10 is in the POWERED status for an hour, the tool 10 may autonomously transition from the POWERED mode to the SLEEP mode. In an alternative, when the predetermined period of time has been met, the power control circuit 16 may facilitate transmission of a signal to nearby electronic device (e.g., smartphone) to request confirmation by a user to transition to the SLEEP status. In this regard, the tool 10 may include the capability to communicate (both transmit and receive) wireless signals to nearby devices. A wireless transceiver may be in communication with the power control circuit 16 to facilitate communication with remote devices.

In this regard, another condition which may cause the tool 10 to transition from the POWERED status to the SLEEP status is the user sending a sleep status command signal at any time. Upon receipt of the sleep status command signal, the tool 10 may autonomously transition from the POWERED status to the SLEEP status.

Yet another condition that may cause the tool 10 to transition from the POWERED status to the SLEEP status is a determination, by the tool 10 or a nearby device, such as the user’s smartphone, that the vehicle 12 is at the end of an operational cycle. For instance, the tool 10 may receive vehicle data or vehicle power signals indicative of the vehicle 12 being placed in park, or the engine being turned off. Furthermore, the tool 10 or the smartphone may become disconnected with a local wireless network (e.g., BLUETOOTH network) of the vehicle 12.

In certain embodiments, the chip set 18 may not be completely deprived of power when in the SLEEP status, and thus, a certain amount of power may continue to be provided to the chip set 18 while the chip set 18 is in the SLEEP status. When the tool 10 is in the SLEEP status, the tool 10 may not be capable of retrieving data from the vehicle 12; however, the tool 10 may remain on standby to quickly transition from the SLEEP status to the POWERED status when one of the triggering conditions are met. The power may be supplied by the same power source (e.g., battery 14 or vehicle 12) that was supplying power when the tool 10 was in the POWERED status. However, the power control circuit 16 may be capable of monitoring the power level of the power source, and if the power level begins to drop, the power control circuit 16 may autonomously transition to another available power source (e.g., switching from battery 14 to vehicle 12, or vice versa) if the power level drops below a predetermined threshold.

To transition the tool 10 from the SLEEP status to the POWERED status the tool 10 may use the vehicle engine being turned on as a triggering condition to effectuate autonomous transition from the SLEEP status to the POWERED status. The tool 10 may be configured to detect a change in the magnitude, profile or other characteristic or parameter of the vehicle power signal to trigger the transition of the tool 10 from the SLEEP status to the POWERED status.

Referring now to FIG. 4, the power control circuit 16 may include a comparator 30 configured to compare an input voltage (e.g., Vref2) received via the diagnostic port 24, e.g., the data link connector (DLC), and compare that input voltage with a reference voltage (e.g., Vref1). A vehicle may include an ignition switch that may have an ACC mode (e.g., an accessory mode) and an ON mode. When in the ACC mode, the electrical accessories like radio, power windows, and/or dashboard lights may operate without starting the engine. This may allow use of these features while the vehicle is parked without running the engine. In the ON mode, all electrical systems may be powered, and the vehicle is prepared for starting. When in the ON mode, the fuel pump may be activated and the ECUs may be powered. In one embodiment, Vref1 has a DC bias voltage more than 0.1V to Vref2. Thus, when a vehicle’s ACC Mode is off, the vehicle’s DLC signal may be equal to zero, such that Vref1-Vref2 is greater than zero, and the Bus_Wakeup signal is at a low level. Conversely, when a vehicle’s ACC mode is on, the vehicle’s DLC signal may have a magnitude of approximately 0.5V added to Vref2 via a capacitor. As such, Vref2-Vref1 is greater than zero. As such, the Bus_Wakeup signal is at a high level. A transition from a low-level Bus_Wakeup signal to a high-level Bus_Wakeup signal may cause the MCU to wake up. When the comparator 30 determines that the engine has been turned on based on the received DLC voltage, the comparator 30 may autonomously generate a wake-up command signal, which may be communicated to the chip set 18 to cause the chip set 18 to transition from the SLEEP status to the POWERED status.

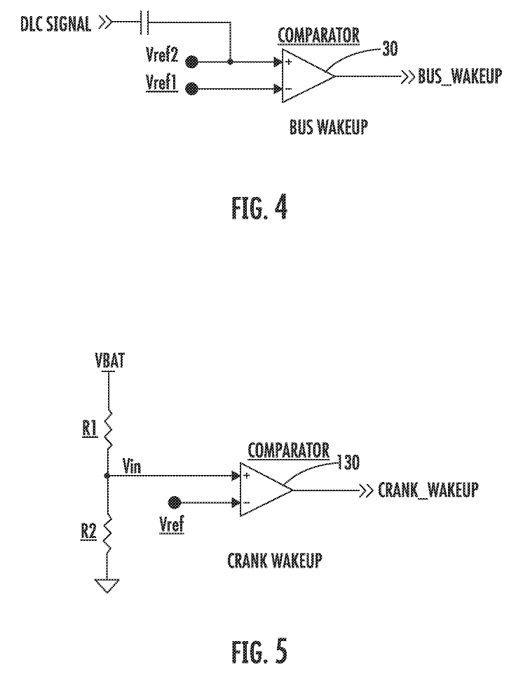

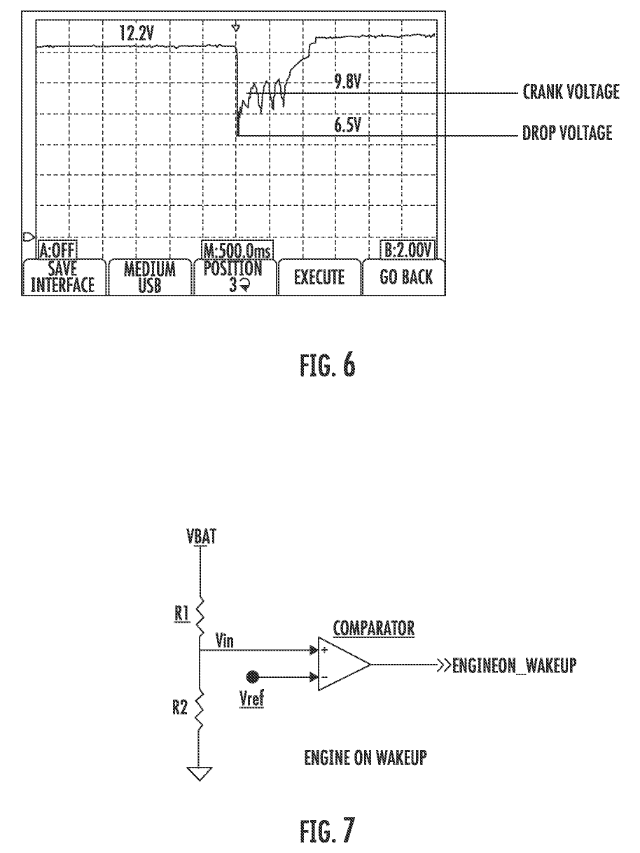

Referring now to FIGS. 5-6, the power control circuit 16 may be configured to detect the engine turning on based on a prescribed voltage profile. In one example, the voltage profile may be associated with voltage changes associated with starting the engine. In more detail, the power control circuit 16 may include comparator 130 and a pair of resistors. The resistors may be operative to divide the voltage of the vehicle battery to a smaller value to be compared to Vref. When the engine cranks, the voltage of the vehicle battery (e.g. Vbat) may change, such that the input voltage (Vin) to the comparator may also change. The comparator will compare the input voltage with a reference voltage (Vref) and when the input voltage is less than the reference voltage, the comparator interprets that relationship as being indicative of the engine turning on. In response thereto, the comparator 130 may autonomously generate a wake-up command signal, which may be communicated to the chip set 18 to cause the chip set 18 to transition from the SLEEP status to the POWERED status. In FIG. 6, Vref is equal to 3.3V. The normal battery voltage is typically greater than 9.5V, such that Vin is greater than Vref, which is indicative of Crank_Wakeup being at a low level. However, during crank, the crank voltage of the battery may be less than 9.5V, such that Vin is less than Vref, which is indicative of Crank_Wakeup being at a high level. When the Crank_Wakewup is at a high level, a signal may be generated by the tool to wake up the MCU.

FIG. 7 depicts an example wherein Vref is equal to 3.3V. R1 and R2 values are selected, with VBAT being equal to 13V minus Vin, which is approximately equal to 3.3V. The normal battery voltage is typically less than 13V, such that Vin is less than Vref, which is indicative of the engine on wakeup being at a low level. When the engine is started, VBAT is greater than 13V, such that Vin is greater than Vref, which is indicative of the engine on wakeup being at a high level, thereby prompting the tool to send a wakeup signal to the MCU.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of facilitating autonomous power source determination and powering-on of an automotive diagnostic tool adapted to retrieve vehicle data from a vehicle, the method comprising the steps of:
receiving a signal from a vehicle via a data link connector on the automotive diagnostic tool;
determining, by a processor on the tool, a power supply status for a chip set on the automotive diagnostic tool as being either a POWERED status, wherein the chip set is powered by a local battery on the automotive diagnostic tool, or an OFF status, wherein the chip set is not receiving power from the local battery on the automotive diagnostic tool; and
when the power supply status is the OFF status, using the vehicle signal to facilitate transition the power supply status of the chip set from the OFF status to the POWERED status.

2. The method recited in claim 1, wherein the step of using the vehicle signal to transition the power supply status of the chip set from the OFF status to the POWERED status includes actuating a POWER BUTTON using the vehicle signal to supply power from a local battery.

3. The method recited in claim 2, further comprising the step of determining whether the power supply status transitioned from the OFF status to the POWERED status after actuating the POWER BUTTON, and when the power status remains in the OFF status, using the vehicle signal to directly provide power to the chip set to transition the power supply status to the POWERED status.

4. The method recited in claim 1, further comprising the step of illuminating a display screen in response to the chip set being transitioned from the OFF status to the POWERED status.

5. The method recited in claim 4, wherein the step of illuminating the display screen occurs independent of any user input being made to the automotive diagnostic tool.

6. The method recited in claim 1, wherein the receiving step, the determining step, and the using step all proceed independent of a user pressing a POWER button.

7. The method recited in claim 1, wherein the chip set is an android chip set.

8. The method recited in claim 1, further comprising the step of sending a wake-up command signal to the chip set.

9. The method recited in claim 8, further comprising the step of detecting an engine of the vehicle being turned on, the step of sending the wake-up command signal being implemented autonomously in response to the detection of the engine being turned on.

10. The method recited in claim 9, wherein the step of detecting the engine of the vehicle being turned on includes detecting a voltage oscillation in a signal received via the data link connector.

11. The method recited in claim 9, wherein the step of detecting the engine of the vehicle being turned on includes detecting a prescribed drop in voltage in the vehicle signal.

12. The method recited in claim 1, wherein the step of receiving the signal from the vehicle via the data link connector on the automotive diagnostic tool is in response to connection of the data link connector to a diagnostic port on the vehicle.

13. An automotive diagnostic tool adapted to retrieve vehicle data from a vehicle and facilitate powering-on of the tool, the automotive diagnostic tool comprising:
a hand-holdable housing;
a data link connector coupled to the housing and configured to be plug-connectable with a diagnostic port on the vehicle;
a chip set within the housing, the chip set being configured to implement a diagnostic functionality of the automotive diagnostic tool;
a battery configured to supply power to the chip set in response to actuation of a POWER BUTTON coupled to the housing; and
a power control circuit configured to:
receive a signal from the vehicle via the data link connector upon connection of the data link connector to a diagnostic port on the vehicle;
determine a power supply status for a chip set on the automotive diagnostic tool as being either a POWERED status, wherein the chip set is powered by the battery on the automotive diagnostic tool, or an OFF status, wherein the chip set is not receiving power from the battery on the automotive diagnostic tool; and
when the power supply status is the OFF status, using the signal from the vehicle to facilitate transition the power supply status of the chip set from the OFF status to the POWERED status.

14. The automotive diagnostic tool recited in claim 13, wherein the power control circuit is configured to actuate a POWER BUTTON in operative communication with the battery to supply power from the battery to facilitate transition of the power supply status of the chip set from the OFF status to the POWERED status.

15. The automotive diagnostic tool recited in claim 14, wherein the power control circuit is further configured to determine whether the power supply status transitioned from the OFF status to the POWERED status after actuating the POWER BUTTON, and when the power status remains in the OFF status, using the signal from the vehicle to directly provide power to the chip set to transition the power supply status to the POWERED status.

16. The automotive diagnostic tool recited in claim 13, further comprising a display screen, wherein the power control circuit is further configured to illuminate the display screen in response to the chip set being transitioned from the OFF status to the POWERED status.

17. The automotive diagnostic tool recited in claim 16, wherein the illumination of the display screen occurs independent of any user input being made to the automotive diagnostic tool.

18. The automotive diagnostic tool recited in claim 13, wherein the functionalities of the power control circuit all proceed independent of a user pressing a POWER button.

19. The automotive diagnostic tool recited in claim 13, wherein the chip set is an android chip set.

20. The automotive diagnostic tool recited in claim 13, wherein the power control circuit is configured to generate a wake-up command signal to the chip set.

21. The automotive diagnostic tool recited in claim 20, wherein the power control circuit is configured to detect an engine of the vehicle being turned on, and generate the wake-up command signal autonomously in response to the detection of the engine being turned on.
